(19) United States
(12) Patent Application Publication
(10) Pub. No.: US 2017/0026332 A1
(43) Pub. Date: Jan. 26, 2017

(54) METHODS, SYSTEMS, AND COMPUTER-READABLE MEDIA FOR PROVIDING COMMUNITY-BASED INFORMATION NETWORKS

(71) Applicant: CARII, INC., Princeton, NJ (US)

(72) Inventor: WunFie LOA, Pilesgrove, NJ (US)

(21) Appl. No.: 15/301,892

(22) PCT Filed: Apr. 6, 2015
(86) PCT No.: PCT/US15/24549

§ 371 Date: Oct. 4, 2016

Related U.S. Application Data
(60) Provisional application No. 61/975,635, filed on Apr. 4, 2014.

(51) Int. Cl. H04L 12/58; H04L 29/08

(52) U.S. Cl. CPC H04L 51/32; H04L 67/306; G06Q 50/01

(57) ABSTRACT

Methods, systems, and computer-readable media for providing an information network service are described. Some embodiments provide a community information network based on virtual groups or communities. The community information network may use community profiles and affiliations configured to facilitate collaboration the communities and members thereof. In some embodiments, elements may be shared as representations of the actual element. In this manner, a user may delete the shared element and cause the deletions of the representations of the actual element used by other members or communities to access the shared element, such that the element is no longer accessible by other users or communities.

### CROSS REFERENCE TO RELATED APPLICATIONS

The present application is a National Stage filing under 35 U.S.C. §371 of International Patent Application No. PCT/US2015/024549, filed on Apr. 6, 2015 and entitled “METHODS, SYSTEMS, AND COMPUTER-READABLE MEDIA FOR PROVIDING COMMUNITY-BASED INFORMATION NETWORKS,” which claims the benefit of U.S. Provisional Application No. 61/975,635 filed on Apr. 4, 2014, the contents of which are incorporated by reference in their entirety as if fully set forth herein.

### BACKGROUND

Network services may provide users with an application or web-based platform for connecting with other users, communicating information, and sharing files, such as digital pictures. Examples of such network services include social network services (or “social networks”), such as Facebook® and LinkedIn®, content sharing services, such as Twitter® and Pinterest®, social enterprise systems, such as Jive®, Lithium®, or Get Satisfaction®. The use of network services has increased dramatically since their inception and they have been integrated into a large number of websites and web-based services, such as e-commerce, news and information, and real-time information platforms. Accordingly, users and businesses now rely heavily on network services, such as social networks, for communication and the sharing of information, which allows them to reach a wider range of the public more effectively and efficiently.

Conventional social networks operate at the individual user level. For example, a user creates a profile on a social network and makes connections with other users. In general, users may either communicate and/or share files with each connection individually or may simultaneously communicate and/or share files with all of their connections (e.g., by posting a message or sharing a file). Although most social networks provide for the formation of groups, such groups are generally loose connections of individual user profiles connected to a common social network profile. Accordingly, conventional social network groups are essentially another individual user profile that operates as a group in name only, without any valuable functionality to provide community-based interaction. As a result, operating and communicating as an actual group using conventional social networks is challenging and generally ineffective. Thus, it would be beneficial to provide network services with virtual groups or communities configured to support and facilitate community engagement and information sharing in a secure and efficient manner.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, a system for managing an information network may include a processor and a non-transitory, computer-readable storage medium in operable communication with the processor. The computer-readable storage medium may include one or more programming instructions that, when executed, cause the processor to generate a plurality of communities and a plurality of members, each of the plurality of members having at least one member-community affiliation with at least one of the plurality of communities, generate community affiliations between the plurality of communities, the community affiliations being configured to define communications between the plurality of communities, receive at least one communication from the at least one member, the at least one communication comprising at least one of posting an element and sharing an element, and transmit the at least one communication to the plurality of communities as a virtual representation of the element, the at least one communication being transmitted based on the affiliations.

In an embodiment, a computer-implemented method for managing an information network, may include, by a processor, generating a plurality of communities and a plurality of members, each of the plurality of members having at least one member-community affiliation with at least one of the plurality of communities, generating community affiliations between the plurality of communities, the community affiliations being configured to define communications between the plurality of communities, receiving at least one communication from the at least one member, the at least one communication comprising at least one of posting an element and sharing an element, and transmitting the at least one communication to the plurality of communities as a virtual representation of the element, the at least one communication being transmitted based on the affiliations

In an embodiment, a computer-readable storage medium having computer-readable program code configured for managing an information network may include computer-readable program code comprising computer-readable program code configured to generate a plurality of communities and a plurality of members, each member having at least one member-community affiliation with at least one of the plurality of communities, computer-readable program code configured to generate community affiliations between the plurality of communities, the affiliations being configured to define communications between the plurality of communities, computer-readable program code configured to receive at least one communication from the at least one member, the at least one communication comprising at least one of posting an element and sharing an element, and computer-readable program code configured to transmit the at least one communication to the plurality of communities as a virtual representation of the element, the at least one communication being transmitted based on the affiliations.

In an embodiment, a system for managing an information network may include a processor and a non-transitory, computer-readable storage medium in operable communication with the processor. The computer-readable storage medium may include one or more programming instructions that, when executed, may cause the processor to generate a plurality of communities and a plurality of members, each of the plurality of members having at least one member-community affiliation with at least one of the plurality of communities and each of the plurality of communities comprising at least one community asset, generate community affiliations between the plurality of communities, the affiliations being configured to define communications between the plurality of communities, wherein each of the plurality of communities is capable of communicating with other of the plurality of communities having a community affiliation therewith and that are in an affiliation path therewith, generate community rights for each of the plurality of communities, the community rights comprising access rights, sharing rights, and administrative rights, receive at least one communication from the at least one member, the at least one communication comprising at least one of posting an element and sharing an element, and transmit the at least one communication to the plurality of communities and at least one external platform as a virtual representation of the element, the at least one communication being transmitted to the plurality of communities based on the affiliations.

### BRIEF DESCRIPTION OF THE DRAWINGS

The above and other objects of the present invention will become more readily apparent from the following detailed description taken in connection with the accompanying drawings.

FIG. 1 depicts an illustrative community information network system according to a first embodiment.

FIG. 2 depicts an illustrative community information network system according to a second embodiment.

FIG. 3 depicts an illustrative information network according to a first embodiment.

FIG. 4 depicts an illustrative information network according to a second embodiment.

FIG. 5 depicts an illustrative information network according to a third embodiment.

FIG. 6 depicts an illustrative information network according to a fourth embodiment.

FIG. 7 illustrates various embodiments of a computing device for implementing the various methods and processes described herein.

### DETAILED DESCRIPTION

The present disclosure generally relates to systems, methods, and non-transitory computer-readable media for providing an information network service. In particular, some embodiments provide an information network service based on groups or communities (the “community information network” or “community information network system”). For instance, the community information network may include functionality for creating group or community profiles and providing for affiliations between such community profiles (or “communities”). The community profiles and the affiliations therebetween may be configured to facilitate collaboration between community profiles through the community information network. In some embodiments, an affiliation generally involves the ability to connect members, communities, groups (for example, a community and one or more members thereof), subgroups, or any combination thereof. In some embodiments, the community information network may be configured as a social network, an information and/or content sharing network, an enterprise application, a social enterprise application, a customer engagement network, or a combination thereof.

In some embodiments, access to the community profiles and/or content (or “elements”) associated therewith may be controlled through public/private designations. In some embodiments, users may share elements with other users and/or communities. Elements may include information, messages, or assets associated with a community or member that may be shared, disseminated, or otherwise communicated therebetween. Non-limiting examples of elements may include digital photographs, videos, electronic files, news, hyperlinks, messages, or the like. In some embodiments, elements may be shared as representations of the actual element. In this manner, a user may delete the shared element and cause the deletions of the representations of the actual element used by other members or communities to access the shared element, such that the element is no longer accessible by other users or communities.

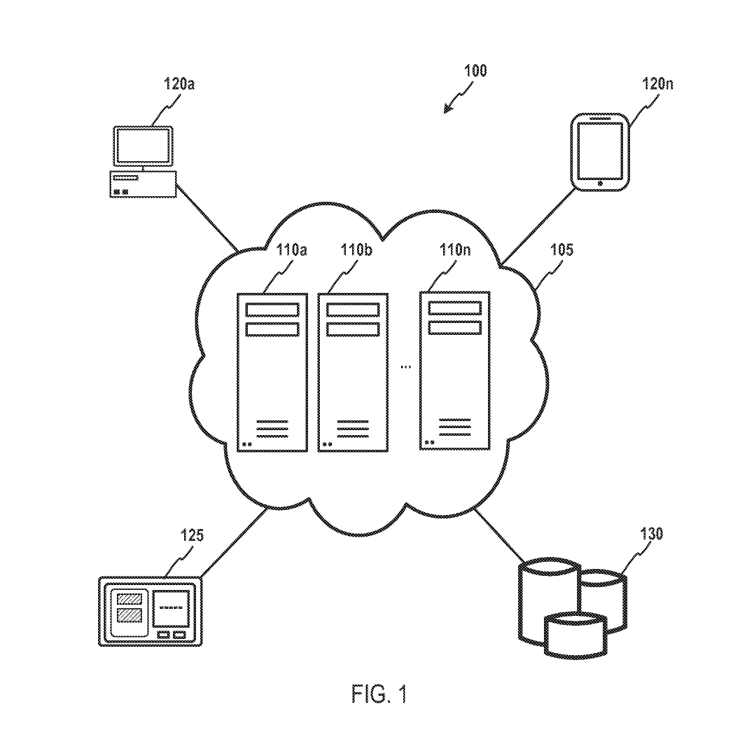

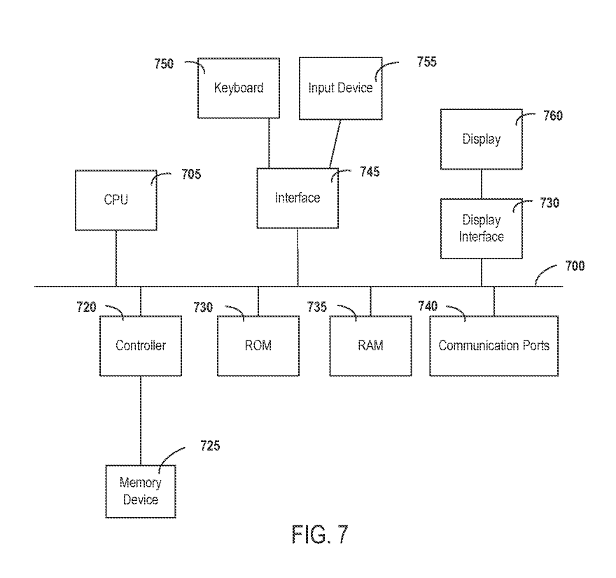

FIG. 1 depicts an illustrative community information network system according to a first embodiment. As shown in FIG. 1, the community information network system 100 may include one or more server logic devices 110a-n, which may generally include a processor, a non-transitory memory or other storage device for housing programming instructions, data or information regarding one or more applications, and other hardware, including, for example, the central processing unit (CPU) 705, read only memory (ROM) 730, random access memory (RAM) 735, communication ports 740, controller 720, and/or memory device 725 depicted in FIG. 7 and described below in reference thereto.

In some embodiments, the programming instructions may include a community information network application (the “information network application”) configured to, among other things, provide a community-based information network according to some embodiments. The server logic devices 110a-n may be in operable communication with client logic devices 120a-n through a network 105, such as the Internet. The client logic devices 120a-n may include, but are not limited to, server computing devices, personal computers (PCs), kiosk computing devices, mobile computing devices, laptop computers, smartphones, personal digital assistants (PDAs), tablet computing devices, or any other logic and/or computing devices now known or developed in the future.

In some embodiments, the information network application may be accessible through various platforms, such as a client application, web-based application, over the Internet, and/or a mobile application (for example, a “mobile app” or “app”). According to some embodiments, the information network application and/or components thereof may be configured to operate on each client logic device 120a-n and/or to operate on a server computing device accessible to logic devices over a network, such as the Internet. All or some of the files, data and/or processes for providing the community information network may be stored locally on each client logic device 120a-n and/or stored in a central location and accessible over a network.

In some embodiments, one or more data stores 115 may be accessible by the client logic devices 120a-120n and/or server logic devices 110a-n. The data stores 115 may include elements used by the information network application for presenting the community-based information network to users through the client logic devices 120a-n. Non-limiting examples of elements stored in the data stores 115 may include digital or electronic files, for instance, digital images, videos, files, messages, user profile information, community information, or the like. In some embodiments, at least a portion of the data stores 115 may include a third-party data source and/or elements from a third-party data source that may be accessed by the client logic devices 120a-n through the community information network.

In some embodiments, the information network application may be in operable communication with various third-party services 125, which may include websites, web-based service providers, and/or content providers. For example, users may be able to use the services of and/or access the data of various third-party web-based services through the information network application (for instance, through the community information network), including, without limitation, Twitter®, Instagram®, Reddit®, Facebook®, LinkedIn®, Paypal®, Gmail, financial institutions, online libraries, applications, and search engines, or the like. In another example, users may be able to use the services of and/or access the data of various third-party content providers including, without limitation, broadcast television network websites, data repositories and/or data feeds (for instance, ESPN®, ABC News®, or the like), content streaming services (for instance, Netflix®, Hulu®, or the like), or the like. In this manner, through the data stores 115 and the third-party services 125, a community information network user or community may access and/or share third-party information, services, or functionality through the community information network.

Although the one or more data stores 115 are depicted as being separate from the logic devices 120a-n, 110a-n, embodiments are not so limited, as all or some of the one or more data stores may be stored in one or more of the logic devices.

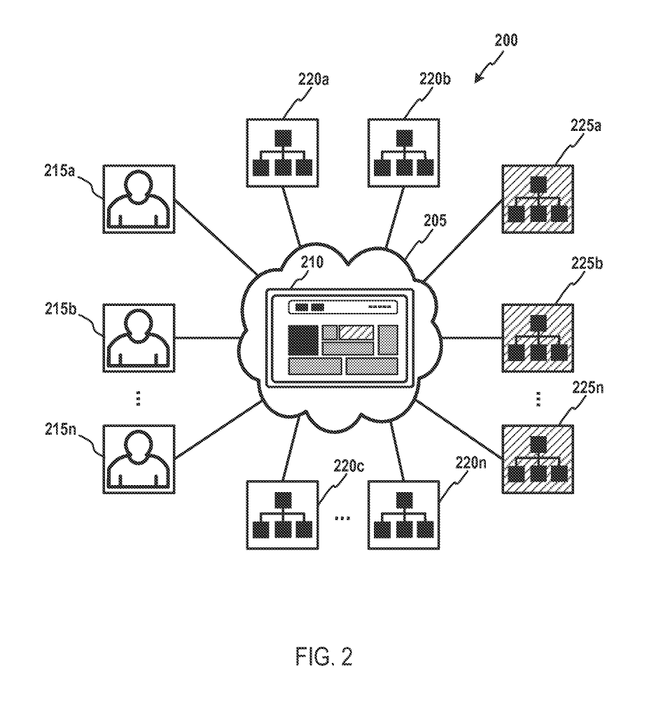

FIG. 2 depicts an illustrative community information network system according to a second embodiment. As shown in FIG. 2, a community information network system 200 may provide access to an information network interface (the “interface”) 210 representing an information network 205 of members 215a-n and communities 220a-n, 225a-n. The interface 210 may provide a graphical representation of the information network 205, its members 215a-n, communities 220a-n, 225a-n, available services, and/or relationships between any of these elements. The interface 210 may also provide users with access to services provided by the community information network system 200, including, without limitation, calendars, access to members 215a-n and communities 220a-n, 225a-n and information associated therewith, accesses to businesses affiliated with the community information network system 200, access to services provided by or affiliated with the community information network system, third-party websites, third-party services, or the like.

In general, users may join the information network and become members 215a-n by creating a user profile via the interface 210. The user profile for each member 215a-n may include various information about the user, including, without limitation, demographic information, personal interests, email information, and access information (for instance, username and password information). In some embodiments, the user profile may be based, at least partially, on a profile associated with a third-party website and/or service (for instance, a Facebook® or Gmail account).

A member 215a-n may form a connection with other members through various methods. For instance, a member 215a may request a connection with another member 215b to form an affiliation therebetween (a “member affiliation”). Responsive to member 215b accepting the connection request from member 215a, member 215b and member 215a may be connected (for instance, become “friends,” “contacts,” “connections,” or the like) within the information network 205. In some embodiments, a member 215a-n may search for other members, for instance, through keyword searching and/or automated/semi-automated searching performed by the information network application based on member information, including email contacts, demographic information, common connections with other members, or the like.

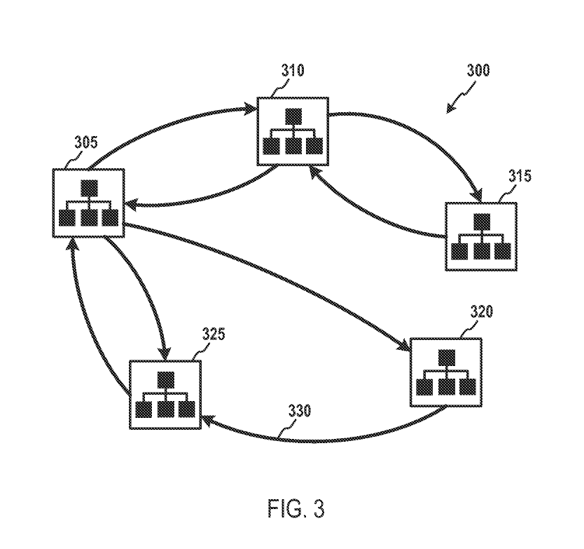

The information network 205 may include communities 220a-n, 225a-n. A member 215a-n may search for and/or join (or become an “affiliate” of) a community 220a-n, 225a-n in a manner the same or substantially similar to forming a connection with another member (a “member-community affiliation”). In addition, a community 220a-n, 225a-n may be an affiliate of another community (a “community affiliation”). Affiliates of a community 220a-n, 225a-n may have community rights within the community, such as access rights, sharing rights, administrative rights, or the like. For instance, access rights may specify affiliate access (for example, read, write, download, or the like) to community assets (for example, files, resources, affiliate information, messages, historical data) or the like. In another instance, sharing rights may specify access to shared elements and/or which affiliates may share elements within the community 220a-n, 225a-n or among accessible communities. In a further instance, administrative rights may specify affiliate capabilities to administer the community, such as accepting connection requests from members 215a-n and/or communities 220a-n, 225a-n, assigning rights to members and/or communities, or the like. In some embodiments, communication among communities and the sharing of elements associated therewith may be based at least partially on affiliations among communities (see FIG. 3, below). In some embodiments, the information network application may facilitate and/or designate affiliations through the creation of a dedicated record in a reference table or other information storage component that defines the relationships between members, communities, groups, subgroups, and any combination thereof.

As shown in FIG. 2, the information network 205 may include public communities 220a-n and private communities 225a-n. In some embodiments, public communities 220a-n may be publicly accessible to members 215a-n and other communities within the information network 205. For example, a member 215a-n and/or community 220a-n, 225a-n may access a public community 220a-n and shared elements thereof (for example, photographs, messages, affiliates, or the like). In some embodiments, only affiliates of a public community 220a-n may modify the public community (for example, post messages, share and/or delete elements, or the like). In some embodiments, all members 215a-n and/or communities 220a-n, 225a-n may modify a public community 220a-n. Although a public community 220a-n is designated as being publicly accessible, certain elements, functionality, and/or affiliates thereof may be designated as private.

The information network 205 may include private communities 225a-n. In general, a private community 225a-n and any elements and/or affiliates associated therewith may not be publicly accessible. In some embodiments, one or more aspects, elements, and/or affiliates of a private community 225a-n may be made accessible to the public or specified non-affiliates, for example, through various security and/or access parameters or settings. For instance, a private community 225a-n may be visible to members 215a-n while the elements of the private group and/or the affiliates thereof may not be accessible or may be visible, but not accessible.

In some embodiments, the community information network system 200 may monitor and/or record member 215a-n and/or community 225a-n activity within the information network system. In some embodiments, the community information network system 200 may reward or otherwise compensate activity by members 215a-n and/or communities 225a-n within the community information network system 200 based on the member 215a-n and/or community 225a-n activity. For example, the community information network system 200 may share revenue with members 215a-n and/or communities 225a-n based on engagement and/or specified actions within the community information network system 200 and components thereof, including, without limitation, forming affiliations, recruiting members 215a-n and/or communities 225a-n, sharing content, communicating with members 215a-n and/or communities 225a-n, and/or generating revenue for the community information network system 200. The compensation may be in various forms, including financial, redeemable points, increased access, increased resources, increased membership capacity, access to and/or increased access to services or businesses, or the like. In some embodiments, the compensation may include a bonus or a certain percentage of revenue generated through the site associated with the member 215a-n and/or community 225a-n activity. In some embodiments, the compensation may include charitable donations. For example, the community information network system 200 may regionally pool or reserve a certain percentage of revenue, and members 215a-n and/or communities 225a-n may apply for grants for local efforts or activities.

FIG. 3 depicts an illustrative information network according to a first embodiment. As shown in FIG. 3, an information network 300 may include a set of communities 305-325. Each of the communities 305-325 may be connected to or affiliated with one or more of the other communities through an affiliation 330. Although multiple affiliations 330 are depicted in FIG. 3, only one is labeled to simplify the figure. The affiliations 330 specify whether a community 305-325 may communicate with another community, such as by accessing elements of another community and/or sending/receiving elements to/from a second community. In some embodiments, communication or the dissemination of information and/or assets by communities 305-325 may include, without limitation, communication internally within a community to all and/or selected members thereof, communication to all and/or selected members of all affiliated communities, or to selected affiliated communities.

Affiliations 330 between communities 305-325 may be configured as being reciprocal (for instance, inclusive) or non-reciprocal (for instance, exclusive). For example, community 305 has an affiliation with community 325 such that community 305 may communicate with community 325. In addition, community 325 also has an affiliation with community 305 such that community 325 may communicate with community 305. As such, community 305 and community 325 have reciprocal affiliations (for example, an inclusive affiliation). In another example, community 305 has an affiliation with community 320 such that community 305 may communicate with community 320. However, community 320 does not have an affiliation with community 305 and, as such, community 320 cannot communicate or communicate directly with community 305 (i.e., a non-reciprocal affiliation or an exclusive affiliation). In some embodiments, a community 305-325 may communicate with non-affiliated communities through a communication path that includes affiliated communities. For instance, community 320 has an affiliation with community 325, which has reciprocal affiliations with community 305. As such, community 320 may communicate with community 325 and community 325 may communicate with community 305. In this manner, community 320 may disseminate information and/or share assets with community 305 via community 325.

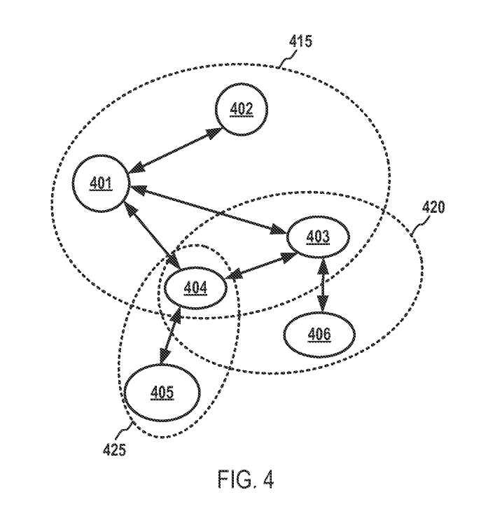

FIG. 4 depicts an illustrative information network according to a second embodiment. As shown in FIG. 4, community 401 has an affiliation 415 with communities 402-404 such that members of community 401 may communicate with all members of communities 402-404, and members of communities 402-404 may only communicate with all members of community 401. Community 403 has an affiliation 420 with communities 404 and 406. Members of community 403 may communicate with all members of communities 404 and 406, and members of communities 404 and 406 can only communicate with all members of community 403. Community 404 is affiliated with community 405. Members of community 404 can communicate with all members of community 405, and members of community 405 can communicate with all members of community 404. Members of community 402 cannot communicate with members of communities 403 and 404 and vice versa. Members of community 404 cannot communicate with members of community 406 and vice versa.

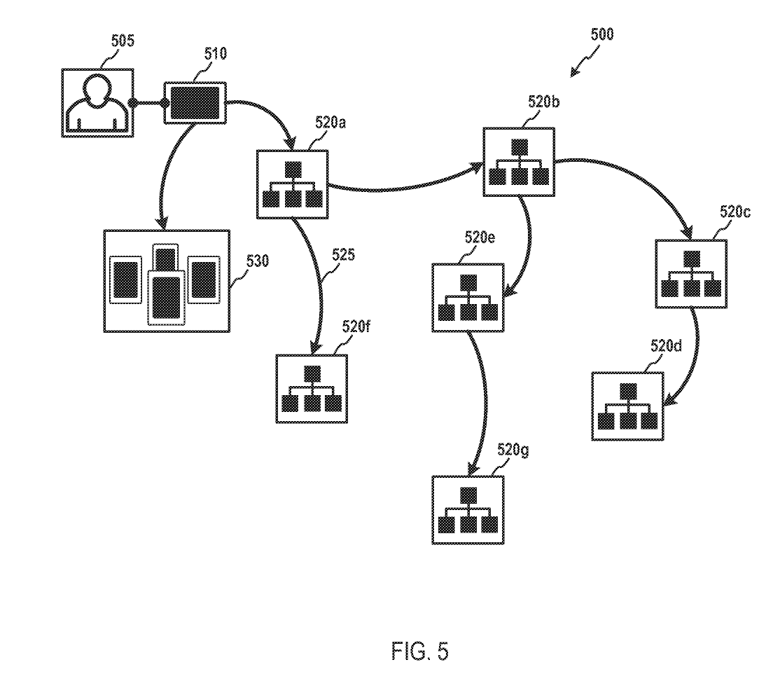

FIG. 5 depicts an illustrative information network according to some embodiments. As shown in FIG. 5, an information network 500 may include communities 520a-g associated through affiliations 525. A member 505 may upload an element 510 for sharing with community 520a. For example, the information network application may present the member 505 with a display object module interface for selecting, uploading, or otherwise processing an element 510. In some embodiments, the member 505 may select to display or “post” and/or share the element 510. Whether the element 510 may be posted or shared within the information network 500 and/or which communities 520a-g may interact with the element may be determined based on element settings for the community and/or member. For instance, whether members 505 of the community 520a-g are able to post and/or share elements 510.

In some embodiments, shared elements 510 may be accessed and/or viewed using various display configurations. An illustrative and non-restrictive display configuration is a carousel configuration 530 which allows for carousel-like (or wrap-around) scrolling through multiple elements 510, such as digital photos, videos, files, postings, or the like. In some embodiments, a member 505 may post a plurality of elements 510 in a single posting or a succession of postings that may be accessible from a single display configuration, such as a carousel configuration 530. For example, a member 505 may be interested in posting information about an event. The member 505 may post elements 510, such as a news article, textual messages, videos, word documents, digital maps, or the like, in a carousel configuration 530. In this manner, other members 505 may access all of the posted information for the invention through the single presentation interface of the carousel configuration 530. In some embodiments, the carousel configuration may be an element 510 that may be shared within the social network 500 or externally similar to the sharing of an individual element.

In some embodiments, a member 510 and/or community 520a-g may access a member and/or community and view or otherwise access all, substantially all, and/or a subset of the elements 510 associated therewith. In this manner, members 505 and communities 520a-g may access the elements 510 associated with members and communities from a single location, for instance, elements posted by the particular members, communities, and/or affiliations thereof.

For example, a member 505 may seek to access all of the elements 510 posted by community 520a and affiliations thereof.

In some embodiments, elements 510 may be shared externally on at least one external platform, for instance, on external network or information sharing systems, such as web sites, social networks, content sharing services, applications, or the like. For example, the member 505 may post an element 510 that is accessible within the information network 500 and/or accessible within an external Internet service (for instance, Facebook®). In this manner, members 505 may post, share, or otherwise make elements 510 accessible outside of the information network 500 via the posting and/or sharing functions of the information network application. Such functionality may allow members 505 to manage external services, web sites, or the like from within the information network 500 interface provided by the information network application.

According to some embodiments, shared elements 510 may be private by default such that the element is initially only available within community 520a. In some embodiments, shared elements 510 may be made public and, as such, may be accessible to all communities 520a-g when shared. In some embodiments, all activities of other members associated with a publicly shared element 510 may also be accessible to all communities, such as a comment to or an edit of the element. The accessibility of such member and/or community 520a-g activities may facilitate a “viral effect” for the element, for example, as other members and/or communities view the activity and respond with their own activity.

In some embodiments, a member 505 (as opposed to a community 520a-g, group, subgroup, or the like) may be the owner of an element 510. The sharing, viewing, or other interaction by other members 505 with the element 510 may be facilitated through the element owner granting permission to any particular member, community, group, subgroup, or the like to the element. In some embodiments, only the owner member 505 may share or post an element 510 (or representation thereof).

In some embodiments, each element 510 may be affiliated with a member 505 or community 520a-g (for example, through metadata). In some embodiments, each element 510 may only be required to be shared or uploaded one time and the uploaded elements may be linked within the information network 500 as representations (or “virtual representations”) of the actual uploaded element. In some embodiments, deleting the uploaded element 510 may delete all shared representations of the object, including within the information network 500 or an external network system, so that the element (or access to the representation of the element) is no longer accessible therein. In some embodiments, each element 510 may be accessible only through its representation such that the element may not be copied, downloaded, or otherwise reproduced or distributed. If a user attempts to access the element 510 through a deleted representation, they will not be able to access the element (for instance, they may receive or otherwise be presented with an “element no longer available” message). In this manner, a member 505 may delete the shared element 510 (or representation thereof) and all access to the shared element will be deleted. Accordingly, the member 505 may control access to the shared element 505 after it has been shared.

As shown in FIG. 5, community 520a is not affiliated with community 520g and, as such, may not disseminate the element 510 to community 520g. In order for private element 510 to be disseminated to community 520g, the element must be disseminated from community 520a to community 520b, to community 520e, and then to community 520g. In some embodiments, the communities 520a-g may only receive a reference to the element 510. As such, if the element 510 was shared with community 520g as described above, deletion of the element by member 505 and/or community 520a would cause the element to no longer be accessible by community 520g, as well as community 520b and community 520e.

In this manner, and in combination with some embodiments described herein, members 505 and communities 520a-g may control access to elements. For example, communities 520a-g may be affiliated with other communities in order to, among other reasons, subscribe to elements from the other communities. For example, community 520e may be affiliated with community 520b in order to receive a news feed or access to digital photographs provided by community 520b. In another example, the information network 500 may be configured to represent a corporate or organizational structure. For instance, each community 520a-e may represent a different corporate department or segment of the organization. In this manner, the organization, such as a charitable organization, may facilitate the sharing and dissemination of information to different segments, such as a fundraising community, a community for a specific charitable event, an administrative community, or the like. In addition, the information network 500 may be configured to form affiliations among communities 520a-e of different entities. In this manner, the information network 500 and the functionality thereof according to some embodiments may facilitate collaboration among different entities in different geographic locations and/or in non-related entities via community affiliations and cross-connections between communities. For example, a charitable organization in New York City may share knowledge, ideas, files, or the like with a different charitable organization in Chicago to facilitate collaboration between the two charitable organizations.

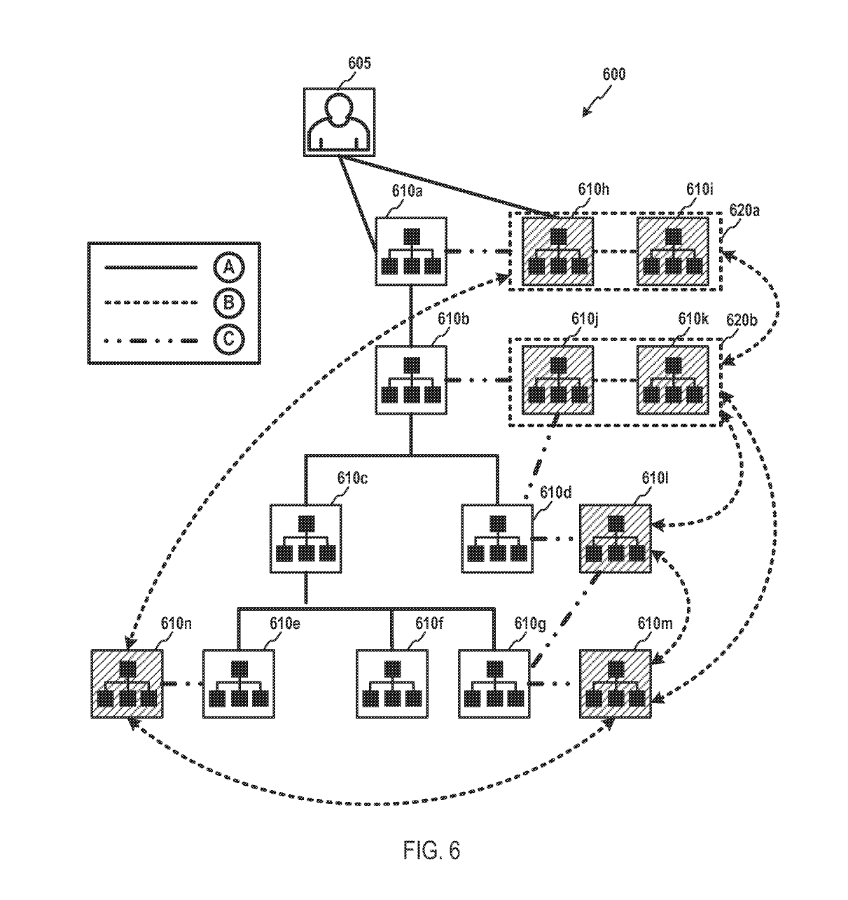

FIG. 6 depicts an illustrative information network according to some embodiments. As shown in FIG. 6, an information network 600 may include members 605 and communities 610a-n. The members 605 may be associated with one or more communities 610a-n. The communities 610a-n may include public communities 610a-g and private communities 610h-n. Public communities 610a-g may be cross-connected through public-public affiliations A. The private communities 610h-n may be formed into private groups 620a, 620b. The private communities 610h-n and/or private groups 620a, 620b may be cross-connected through private-private affiliations B. The public communities 610a-g and the private communities 610h-n and/or private groups 620a, 620b may be cross-connected through public-private affiliations C. In this manner, communities 620a-n may be cross-connected through the various affiliations A, B, C and communication may be established therebetween through any path (an “affiliation path”) formed through the affiliations. For example, public community 610a may be cross-connected with private community 610m through the affiliations between community 610a, group 620a, group 620b, and community 610m, and vice versa. In this manner, the information network 600 configured according to some embodiments may facilitate communication and collaboration among members 605 and communities 610a-n, while maintaining the requisite privacy and security of the information network members and communities.

FIG. 7 depicts a block diagram of exemplary internal hardware that may be used to contain or implement the various computer processes and systems as discussed above. A bus 700 serves as the main information highway interconnecting the other illustrated components of the hardware. CPU 705 is the central processing unit of the system, performing calculations and logic operations required to execute a program. CPU 705, alone or in conjunction with one or more of the other elements disclosed in FIG. 7, is an exemplary processing device, computing device or processor as such terms are used within this disclosure. Read only memory (ROM) 730 and random access memory (RAM) 735 constitute exemplary memory devices.

A controller 720 interfaces with one or more optional memory devices 725 to the system bus 700. These memory devices 725 may include, for example, an external or internal DVD drive, a CD ROM drive, a hard drive, flash memory, a USB drive or the like. As indicated previously, these various drives and controllers are optional devices. Additionally, the memory devices 725 may be configured to include individual files for storing any software modules or instructions, auxiliary data, common files for storing groups of results or auxiliary, or one or more databases for storing the result information, auxiliary data, and related information as discussed above.

Program instructions, software or interactive modules for performing any of the functional steps associated with various embodiments described above may be stored in the ROM 730 and/or the RAM 735. Optionally, the program instructions may be stored on a tangible computer-readable medium such as a compact disk, a digital disk, flash memory, a memory card, a USB drive, an optical disc storage medium, such as a Blu-ray™ disc, and/or other recording medium.

An optional display interface 730 may permit information from the bus 700 to be displayed on the display 760 in audio, visual, graphic or alphanumeric format. The information may include information related to a current job ticket and associated tasks. Communication with external devices may occur using various communication ports 740. An exemplary communication port 740 may be attached to a communications network, such as the Internet or a local area network.

The hardware may also include an interface 745 which allows for receipt of data from input devices such as a keyboard 750 or other input device 755 such as a mouse, a joystick, a touch screen, a remote control, a pointing device, a video input device and/or an audio input device.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which alternatives, variations and improvements are also intended to be encompassed by some embodiments described herein.

What is claimed is:

1. A system for managing an information network, the system comprising:
a processor; and
a non-transitory, computer-readable storage medium in operable communication with the processor, wherein the computer-readable storage medium contains one or more programming instructions that, when executed, cause the processor to:
generate a plurality of communities and a plurality of members, each of the plurality of members having at least one member-community affiliation with at least one of the plurality of communities,
generate community affiliations between the plurality of communities, the community affiliations being configured to define communications between the plurality of communities,
receive at least one communication from the at least one member, the at least one communication comprising at least one of posting an element and sharing an element, and
transmit the at least one communication to the plurality of communities as a virtual representation of the element, the at least one communication being transmitted based on the affiliations.

2. The system of claim 1, wherein the information network is configured as one of a social network, a content sharing network, and a social enterprise network.

3. The system of claim 1, wherein the community affiliations are configured as at least one of a reciprocal affiliation and a non-reciprocal affiliation.

4. The system of claim 1, wherein the plurality of communities includes public and private communities.

5. The system of claim 1, wherein the computer-readable storage medium further contains one or more programming instructions that, when executed, cause the processor to reward at least one of the plurality of members based on member activity within the information network.

6. The system of claim 5, wherein the member activity includes at least one of forming affiliations, recruiting members, recruiting communities, sharing content, posting content, communicating with members, communicating with communities, and generating revenue for the information network.

7. The system of claim 5, wherein the reward comprises at least one of financial compensation, redeemable points, increased access, increased resources, increased membership capacity, increased access to services, percentage of information network revenue, and charitable donations.

8. The system of claim 1, wherein the computer-readable storage medium further contains one or more programming instructions that, when executed, cause the processor to:
reserve a local revenue percentage of information network revenue,
receive at least one grant request from at least one of the plurality of communities for a local activity, and
grant at least a portion of the local revenue percentage to the at least one grant request.

9. The system of claim 1, wherein the computer-readable storage medium further contains one or more programming instructions that, when executed, cause the processor to transmit the at least one communication to at least one external platform.

10. A computer-implemented method for managing an information network, the method comprising, by a processor:
generating a plurality of communities and a plurality of members, each of the plurality of members having at least one member-community affiliation with at least one of the plurality of communities,
generating community affiliations between the plurality of communities, the community affiliations being configured to define communications between the plurality of communities,
receiving at least one communication from the at least one member, the at least one communication comprising at least one of posting an element and sharing an element, and
transmitting the at least one communication to the plurality of communities as a virtual representation of the element, the at least one communication being transmitted based on the affiliations.

11. The method of claim 10, wherein the information network is configured as one of a social network, a content sharing network, and a social enterprise network.

12. The method of claim 10, wherein the community affiliations are configured as at least one of a reciprocal affiliation and a non-reciprocal affiliation.

13. The method of claim 10, wherein the plurality of communities includes public and private communities.

14. The method of claim 10, further comprising rewarding at least one of the plurality of members based on member activity within the information network.

15. The method of claim 14, wherein the member activity includes at least one of forming affiliations, recruiting members, recruiting communities, sharing content, posting content, communicating with members, communicating with communities, and generating revenue for the information network.

16. The method of claim 14, wherein the reward comprises at least one of financial compensation, redeemable points, increased access, increased resources, increased membership capacity, increased access to services, percentage of information network revenue, and charitable donations.

17. The method of claim 10, further comprising:
reserving a local revenue percentage of information network revenue,
receiving at least one grant request from at least one of the plurality of communities for a local activity, and
granting at least a portion of the local revenue percentage to the at least one grant request.

18. The method of claim 10, further comprising transmitting the at least one communication to at least one external platform.

19. A computer-readable storage medium having computer-readable program code configured for managing an information network, the computer-readable program code comprising:
computer-readable program code configured to generate a plurality of communities and a plurality of members, each member having at least one member-community affiliation with at least one of the plurality of communities;
computer-readable program code configured to generate community affiliations between the plurality of communities, the affiliations being configured to define communications between the plurality of communities;
computer-readable program code configured to receive at least one communication from the at least one member, the at least one communication comprising at least one of posting an element and sharing an element; and
computer-readable program code configured to transmit the at least one communication to the plurality of communities as a virtual representation of the element, the at least one communication being transmitted based on the affiliations.

20. The computer-readable storage medium of claim 19, wherein the information network is configured as one of a social network, a content sharing network, and a social enterprise network.

21. The computer-readable storage medium of claim 19, wherein the community affiliations are configured as at least one of a reciprocal affiliation and a non-reciprocal affiliation.

22. The computer-readable storage medium of claim 19, wherein the plurality of communities may include public and private communities.

23. The computer-readable storage medium of claim 19, further comprising computer-readable program code configured to reward at least one of the plurality of members based on member activity within the information network.

24. The computer-readable storage medium of claim 23, wherein the member activity includes at least one of forming affiliations, recruiting members, recruiting communities, sharing content, posting content, communicating with members, communicating with communities, and generating revenue for the information network.

25. The computer-readable storage medium of claim 23, wherein the reward may comprise at least one of financial compensation, redeemable points, increased access, increased resources, increased membership capacity, increased access to services, percentage of information network revenue, and charitable donations.

26. The computer-readable storage medium of claim 19, further comprising:
computer-readable program code configured to reserve a local revenue percentage of information network revenue,
computer-readable program code configured to receive at least one grant request from at least one of the plurality of communities for a local activity, and
computer-readable program code configured to grant at least a portion of the local revenue percentage to the at least one grant request.

27. The computer-readable storage medium of claim 19, further comprising computer-readable program code configured to transmit the at least one communication to at least one external platform.

28. A system for managing an information network, the system comprising:
a processor; and
a non-transitory, computer-readable storage medium in operable communication with the processor, wherein the computer-readable storage medium contains one or more programming instructions that, when executed, cause the processor to:
generate a plurality of communities and a plurality of members, each of the plurality of members having at least one member-community affiliation with at least one of the plurality of communities and each of the plurality of communities comprising at least one community asset,
generate community affiliations between the plurality of communities, the affiliations being configured to define communications between the plurality of communities, wherein each of the plurality of communities is capable of communicating with other of the plurality of communities having a community affiliation therewith and that are in an affiliation path therewith,
generate community rights for each of the plurality of communities, the community rights comprising access rights, sharing rights, and administrative rights, receive at least one communication from the at least one member, the at least one communication comprising at least one of posting an element and sharing an element, and
transmit the at least one communication to the plurality of communities and at least one external platform as a virtual representation of the element, the at least one communication being transmitted to the plurality of communities based on the affiliations.
